(19) United States
(12) Patent Application Publication
(10) Pub. No.: US 2022/0324402 A1
(43) Pub. Date: Oct. 13, 2022

(54) VEHICLE SIDE COLLISION OCCUPANT RESTRAINT SYSTEM

(71) Applicant: Einspahr L.L.C., Madison, WI (US)

(72) Inventor: John Einspahr, Madison, WI (US)

(21) Appl. No.: 17/691,420

(22) Filed: Mar. 10, 2022

Related U.S. Application Data
(60) Provisional application No. 63/174,404, filed on Apr. 13, 2021.

(51) Int. Cl. B60R 21/18; B60R 22/26; B60R 22/195

(52) U.S. Cl. CPC B60R 21/18; B60R 22/26; B60R 22/1954; B60R 2022/027

(57) ABSTRACT

A safety restraint system for a vehicle that includes seat belts that extend over both side pelvic portions and both side rib cage portions of the vehicle occupant and directly prevents inward and outward lateral displacement of the side pelvic portions and side rib cage portions during a side collision event. Said side belts attach to a forward-facing seat belt system with two shoulder belts, one on either side of the neck, for improved performance on the torso in a collision event, and a lap belt, while still maintaining the convenience of a single buckle click task for the occupant to secure the belt system.

### CROSS-REFERENCE TO RELATED APPLICATIONS

This application claims priority to and the benefit of U.S. Provisional Application No. 63/174,404, entitled “Vehicle Side Collision Occupant Restraint System”, filed on Apr. 13, 2021, which is incorporated by reference herein in its entirety for all purposes.

### TECHNICAL FIELD

The present invention relates to automobile safety restraint systems and minimizing and delaying the contact with and the load exerted on a vehicle occupant by a vehicle interior structure and other occupants during a side collision event.

### BACKGROUND OF THE INVENTION

Vehicles often use various passive and active safety restraint systems to protect vehicle occupants from injury during collision events. The passive restraint systems may include load absorbing and occupant deflecting. materials, seat belts, and airbags. The active restraint systems may include steering and brake control. The restraint systems typically include collision severity sensors, which are used to gather information for control and deployment of the restraints.

To evaluate and develop existing and new restraint systems, various computer simulations, sled tests, and vehicle collision tests are often performed. The vehicle tests include barrier and vehicle-to-vehicle collision testing. Several testing procedures and requirements exist for such evaluation. The Insurance Institute for Highway Safety (IIHS), for example, has side impact assessments. Federal motor vehicle safety standards also exist for side collision testing.

Evaluation criteria for vehicles may continue to expand based on expanding demand for improvements from governments and consumers. Also, there is a high value in improving health outcomes of vehicle occupants in collisions even if demands for those improvements are limited, since it results in a reduction in losses for the occupants and their communities.

To improve side collision performance of a vehicle during a side collision event, vehicle side structures have been reinforced and superior interior restraints have been designed. The structures have included B-pillars, roof rails, rocker panels, and doors.

Some current interior restraints that have been modified include, upper side and pelvic airbags, and foam blocks. The upper side airbags are limited in their ability to protect the lower portions of an occupant body, such as the pelvic region. The pelvic airbags are also limited due to the amount of space available between an interior door trim panel and an occupant pelvis and the small amount of time available in a collision event to deploy a pelvic airbag. Airbags may also have a more limited ability to handle multiple collisions during the same event than seat belts. Foam blocks have significantly more width than seat belts and pre-deployed airbags and so they limit the amount of cabin space available to occupants.

Existing seat belts predominantly use a single shoulder belt on one side of the occupant's neck (three-point system). This configuration limits the incorporation of a side seat belt to only one of the occupant's two sides, leaving the other side more vulnerable to injury as a result of striking vehicle structures or other occupants during a collision. U.S. Publ. Appl. No. 2006/0090946A1 describes one such system in which a seat belt buckle and a retractor are mounted approximately at or below a pelvic level of a vehicle occupant, such that a seat belt extends over a side pelvic portion of the vehicle occupant and directly prevents outward lateral displacement of the side pelvic portion during a side collision event. U.S. Pat. No. 6,592,166 describes a vehicle occupant protection system utilizing a single shoulder belt and single side torso belt in which a seat fitted with the seat belt is laterally moveably supported by a floor and coupled with a power actuator for accelerating the seat laterally toward a central part of the vehicle body upon detection of a side crash and a brake means for applying an opposite force to the seat after it has traveled a certain distance toward the central part of the vehicle body. U.S. Pat. No. 6,773,075 describes a four-point seat belt system for restraining a vehicle occupant in a vehicle seat with two shoulder belts mounted on a common retractor mechanism, and connected to a lap belt, which is buckled centrally on the abdomen of the occupant. However, this system does not include close-proximity side restraints for the pelvis or the torso on either side of the occupant.

Thus, there exists a need for an improved side safety restraint system that minimizes and delays the contact with and the load exerted on a vehicle occupant by vehicle structures and other occupants on both of their sides during a side collision event, while still maintaining the convenience of a single buckle fastening task.

### SUMMARY OF THE INVENTION

The present invention provides a safety restraint system for a vehicle that comprises one or two pairs of restraining belts, each such pair extending substantially horizontally behind and over the respective sides of the pelvic portions or over and behind the respective sides of the rib cage portions of the vehicle occupant or, when two pairs of restraining belts are present, behind/over both the pelvic portions and the rib-cage portions of the vehicle occupant. The positioning and anchoring of these restraining belts operate, when present, to directly prevent inward and outward lateral displacement of the side pelvic portions and side rib cage portions of the occupant during a side collision event. These restraining belts may be attached to a conventional forward facing seat belt system, for example, a system comprising two conventional shoulder belts, one situated on either side of the neck, affixed to the respective sides of a center-buckling lap belt restraint system. Such a combination results in improved performance as a side restraint during a collision event, with the further advantage of maintaining the convenience of a single center buckle click task for the occupant in order to secure the entire belt restraint system. Accordingly, in one aspect the present invention provides, in a restraint belt system for a seat in a vehicle consisting essentially of lap belt having two sides that connect through a center buckle and a pair of shoulder belts, each of said shoulder belts affixed to and extending from one of the respective sides of said lap belt to respective anchor points positioned to permit each of said shoulder belts to extend over a shoulder of an occupant of the seat to be restrained by the system, the improvement comprising at least one pair of side restraining belts, each pair extending substantially horizontally, and each pair positioned either (1) behind and over the respective sides of the pelvic portions of said occupant or (2) over and behind the respective sides of the rib cage portions of the vehicle occupant, said restraining belts being affixed on one side of said center-buckle lap belt or to one of said shoulder belts, and said restraining belts being anchored directly or indirectly within the vehicle at the other end in a manner to afford the occupant a side restraint during a collision.

The present invention provides several advantages with respect to conventional belt restraint systems. One such advantage is the provision of a seat belt system that restrains and/or prevents both outward and inward lateral displacement of a rib cage and/or pelvis of an occupant during a collision event. Preventing lateral displacement of the rib cage and pelvis increases the amount of time between when an object contacts the side of the vehicle and when an interior panel or structure, or another occupant comes in contact with the occupant, It also prevents the occupant's body being ejected from the restraint system during a collision. The increase in time allows for increased collision energy absorption before occupant contact, thus decreasing the loads exerted on the occupant and deflections of occupant body parts.

Another advantage of the present invention is the provision of a fully integrated seat belt system including both side impact protection and conventional frontal impact protection, while still only requiring the occupant to connect the belt system with a single center buckle click task. The integration with a pair of shoulder straps, rather than a single-shoulder-strap system better distributes the load on the body during a collision, thereby reducing incidence of injury.

The present invention itself, together with attendant advantages, will be best understood by reference to the following detailed description, taken in conjunction with the accompanying figures.

### BRIEF DESCRIPTION OF THE DRAWING

FIG. 1 provides a front view of the aspects of the present invention that incorporate the integration of a lateral restraining system comprising two pairs of side restraining belts integrated with a conventional seat belt restraint system comprising a pair of shoulder belts affixed to a center-buckle lap belt system.

### DETAILED DESCRIPTION

In general, the fundamental function of interior restraints is to keep an occupant away from the structure or other occupants of a vehicle and to absorb forces on the occupant's body during a collision event. The present invention provides such restraint and absorption, which is described in detail below.

The present invention may also be applied in automobile and non-automobile applications.

In the following description, various operating parameters and components are described for one constructed embodiment. These specific parameters and components are included as examples and are not meant to be limiting.

Also, in the following description the term “performing” may include activating, deploying, initiating, powering, and other actions known in the art that may describe the manner in which a countermeasure may be operated.

Additionally, in the following description the term “countermeasure” may refer to an object or may refer to an action. For example, a countermeasure may be performed or a countermeasure may be activated. An airbag is a countermeasure. A controller may perform a countermeasure by signaling the airbag to deploy.

Moreover, a countermeasure device may be any device within an automotive vehicle that is used in conjunction with a collision countermeasure system including: a controller, a vehicle system, an indicator, or other countermeasure device known in the art.

In addition, the term “collision type”' refers to collision severity and collision contact location of a collision. Collision type may include whether a collision is a frontal-oblique, side, offset, or head-on collision, as well as refer to other collision location type descriptions known in the art. A collision type may also include information related to relative size, weight, and collision change-in-velocity, as well as other collision type related information known in the art.

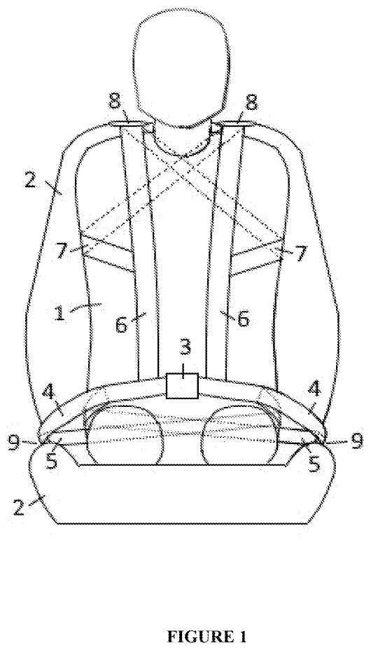

Referring now to FIG. 1, a front view of a lateral restraining system incorporating side seat belts in accordance with an embodiment of the present invention is shown. The lateral restraining system prevents lateral displacement of vehicle occupants 1 during a collision event. The term “lateral displacement” refers to a horizontal direction perpendicular to and away from a longitudinal centerline of the vehicle.

The lateral system may include multiple additional seat belts with side belts and accompanying retractors, D-rings, buckles and corresponding receivers, and anchors. The seat belts may also have corresponding pretensioners and pyrotechnic devices, which may be located within or coupled to the retractors and the receivers. The side belts may be inflatable. The seat belts, the retractors, the D-rings, the buckles, the receivers, the pretensioners and pyrotechnic devices may all be of various types and styles and be in various configurations. The seat belts reside over the occupants and the seats. Some of the retractors, D-rings, and anchors may be coupled to the seat frames or to the vehicle chassis, as desired.

A controller may be coupled to collision sensors, retractors, the buckle 3, the receiver, and to the side belts, as well as to various pretensioners and pyrotechnic devices associated therewith. The controller may activate and control the operation of the stated items during a collision event. The pretensioners and pyrotechnic devices may include solenoids and electric motors. The pretensioners pull in on the associated seat belts to take up any slack in the belts and prevent the belts from extending during a collision event.

The lap belts 4 are coupled between lap belt anchors 9 and the buckle 3. The lap belt anchors 9 are located on the sides of the seat structure 2 or coupled to the vehicle chassis directly. The lap belts 4 extend from the lap belt anchors 9 across a pelvis of the occupant 1 to the buckle 3.

The shoulder belts 6 are coupled between shoulder belt anchors 8 and the lap belts 4 or buckle 3. The shoulder belt anchors 8 are located behind the occupant's shoulders on the vehicle chassis (e.g. harness bar) or to the seat structure 2 if designed and sized for seat belt forces. The shoulder belts 6 extend from the shoulder belt anchors 8 over the shoulders of the occupant 1, down the chest and abdomen to the lap belts 4 or buckle 3.

The lap side belts 5 may be coupled in various locations onto the lap belts 4 or buckle 3, including integrally stitched into or with the lap belts 4, as shown, or may be coupled via a clasp (not shown) or may be fastened, adhered, or attached using some other method known in the art. The second ends of the lap side belts 5 are coupled to a side lap belt anchor point or retractor or to the lap belt anchor point 9 on the other side of the seat such that the lap side belts wrap behind and around the sides of the pelvis to provide immediate lateral restraint during a collision event. The coupling method is such to withstand loading during a collision event. The lap side belt anchor points or retractors are located a distance away from the structures meant to be avoided by the restraint of the belt in a collision and are further from those structures laterally than the side of the pelvis itself. The lap side belt anchor point or retractor may be located in the seat structure 2 or vehicle chassis.

The rib cage side belts 7 may be coupled in various locations onto the shoulder belts 6 or buckle 3, including integrally stitched into or with the shoulder belts 6, as shown, or may be coupled via a clasp (not shown) or may be fastened, adhered, or attached using some other method known in the art. The second ends of the rib cage side belts 7 are coupled to a rib cage side belt anchor point or retractor or to the shoulder belt anchor 8 on the opposite side of the seat such that the rib cage side belts wrap around the sides of and then extend behind the rib cage to provide immediate lateral restraint during a collision event. The coupling method is such to withstand loading during a collision event. The rib cage side belt anchor points or retractors are located a distance away from the structures meant to be avoided by the restraint of the belt in a collision and are further from those structures laterally than the side of the rib cage itself. The rib cage side belt anchor point or retractor may be located in the seat structure 2, if designed and sized for seat belt forces, or vehicle chassis (e.g. harness bar).

The present invention is a vehicle safety system that provides lateral restraining systems that may be used to further prevent injury-causing contact between a vehicle occupant and vehicle structures and other occupants during a side collision event. The present invention further prevents loads from being exerted on and bodily deflections experienced by a vehicle occupant. Thus, the present invention provides an improved safety restraint system that further prevents injury to a vehicle occupant during a side collision event.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. In a restraint belt system for a seat in a vehicle consisting essentially of lap belt having two sides that connect through a center buckle and a pair of shoulder belts, each of said shoulder belts affixed to and extending from one of the respective sides of said lap belt to respective anchor points positioned to permit each of said shoulder belts to extend over a shoulder of an occupant of the seat to be restrained by the system, the improvement comprising:
at least one pair of side restraining belts, each pair extending substantially horizontally, and each pair positioned either (1) behind and over the respective sides of the pelvic portions of said occupant or (2) over and behind the respective sides of the rib cage portions of the vehicle occupant, said restraining belts being affixed on one side of said center-buckle lap belt or to one of said shoulder belts, and said restraining belts being anchored directly or indirectly within the vehicle at the other end in a manner to afford the occupant a side restraint during a collision.

2. The improvement according to claim 1 wherein two pairs of side restraining belts extend substantially horizontally both (1) behind and over the respective sides of the pelvic portions of said occupant or (2) over and behind the respective sides of the rib cage portions of the vehicle occupant.

3. The improvement according to claim 2 wherein pairs of side restraining belts extending substantially horizontally behind and over the respective sides of the pelvic portions of said occupant are each affixed at one end to one of the respective sides of the center-buckle lap belt.

4. The improvement according to claim 2 wherein pairs of side restraining belts extending substantially horizontally over and behind the respective sides of the rib-cage portions of said occupant are each respectively affixed at one end to one of the horizontal shoulder belts.

5. The improvement according to claim 2 wherein (1) pairs of side restraining belts extending substantially horizontally behind and over the respective sides of the pelvic portions of said occupant are each affixed at one end to one of the respective sides of the center-buckle lap belt and (2) pairs of side restraining belts extending substantially horizontally over and behind the respective sides of the rib-cage portions of said occupant are each respectively affixed at one end to one of the horizontal shoulder belts.

6. The improvement according to claim 5 wherein the pairs of side restraining belts extending substantially horizontally behind and over the respective sides of the pelvic portions of said occupant are each affixed at the other end to directly or indirectly to the frame of the vehicle.

7. The improvement according to claim 5 wherein pairs of side restraining belts extending substantially horizontally over and behind the respective sides of the rib-cage portions of said occupant are each respectively affixed at the other end directly or indirectly to the frame of the vehicle.

8. The improvement according to claim 5 wherein both the pairs of side restraining belts extending substantially horizontally behind and over the respective sides of the pelvic portions of said occupant and pairs of side restraining belts extending substantially horizontally over and behind the respective sides of the rib-cage portions of said occupant are each respectively affixed at the other end directly or indirectly to the frame of the vehicle.

9. The improvement according to claim 8 wherein the direct or indirect anchor to the frame of the vehicle for each of the pairs of side restraining belts extending substantially horizontally behind and over the respective sides of the pelvic portions of said occupant is the indirect anchor for a side of the center-buckle lap belt.

10. The improvement according to claim 8 wherein the direct or indirect anchor to the frame of the vehicle for each of the pairs of side restraining belts extending substantially horizontally over and behind the respective sides of the rib-cage portions of said occupant is the indirect anchor for a one of the pair of horizontal shoulder belts.

11. The improvement according to claim 8 wherein (1) the direct or indirect anchor to the frame of the vehicle for each of the pairs of side restraining belts extending substantially horizontally behind and over the respective sides of the pelvic portions of said occupant is the indirect anchor for a side of the center-buckle lap belt and (2) the direct or indirect anchor to the frame of the vehicle for each of the pairs of side restraining belts extending substantially horizontally over and behind the respective sides of the rib-cage portions of said occupant is the indirect anchor for a one of the pair of horizontal shoulder belts.

12. A safety restraint belt system for a vehicle containing a seat for an occupant comprising:
at least one seat belt buckle;
at least one mounting points, force redirection points (anchor), or retractors mounted further from the vehicle structures and other occupants which could be contacted in a collision than the restraint areas on the side of the occupant's body.
at least two seat belts extending at least partially over each side pelvic or side rib cage portions of said vehicle occupant, each directly preventing lateral displacement of said side pelvic or side rib cage portions during a side collision event.

13. A system according to claim 12 wherein said at least two seat belts comprise two lap belt portions that extend at least partially around said side pelvic portion and two side rib cage belt portions that extend at least partially around said side rib cage portions.

14. A system according to in claim 12 wherein said at least two seat belts comprise side seat belts comprising:
two first ends coupled to said at least one buckle or lap seat belt; and two second ends coupled to said at least one mounting points, force redirection points (anchors), or retractors, and
two first ends coupled to said shoulder belts or buckle; and two second ends coupled to said at least one mounting points, force redirection points (anchors), or retractors.

15. A system according to claim 12 wherein said at least one seat belt comprises:
a lap belt; and
two side belts coupled to said lap belt or buckle; and
two shoulder belts; and two side belts coupled to said shoulder belts or buckle.

16. A system according to claim 15 wherein said lateral restraining system removes slack in said side belts.

17. A system according to claim 15 wherein said lateral restraining system comprises a pyrotechnic device that retracts said side belts during said collision event.

18. A system according to claim 15 wherein said lateral restraining system comprises at least one pretensioner that retracts said side belts during said collision event.

19. A system according to claim 15 wherein at least a portion of said side belts inflates during said collision event.

20. A system according to claim 12 wherein said at least two seat belts comprises a shoulder belt system.
